(19) United States
(12) Patent Application Publication
(10) Pub. No.: US 2014/0068445 A1
(43) Pub. Date: Mar. 6, 2014

(54) Systems and Methods for Mobile Access to Enterprise Work Area Information

(71) Applicants: Dirk Kempf, Walldorf (DE); Uwe Pfisterer, Sandhausen (DE); Tobias-Alexander Storz, Moosburg an der Isar (DE); Victor Nakonechny, Heidelberg (DE); Norbert Bröker, Rauenberg (DE)

(72) Inventors: Dirk Kempf, Walldorf (DE); Uwe Pfisterer, Sandhausen (DE); Tobias-Alexander Storz, Moosburg an der Isar (DE); Victor Nakonechny, Heidelberg (DE); Norbert Bröker, Rauenberg (DE)

(73) Assignee: SAP AG, Walldorf (DE)

(21) Appl. No.: 13/605,797

(22) Filed: Sep. 6, 2012

(51) Int. Cl. G06F 3/01

(52) U.S. Cl. 715/736

(57) ABSTRACT

Example systems and methods of mobile access to enterprise work area information are presented. In one example, a floor plan of a work area that includes a number of workcenters is displayed. Representations of the workcenters are also displayed with the floor plan according to their physical locations within the work area. Information describing an operational status of at least one of the workcenters is received from an enterprise resource planning system. This information is visibly linked with the representation of its associated workcenter.

### BACKGROUND

A multitude of businesses, especially manufacturers, distributors, retailers, and other entities, often maintain a warehouse, shipping department, shop floor, or other area in which goods or items are received, manufactured, assembled, boxed, and/or shipped. Such a building, or area within a building, may be termed a “work area.” Further, a work area may house a number of separately identifiable, functional groups, departments, or “workcenters,” each of which may occupy a specific portion of the overall work area. Such workcenters may include, for example, receiving, initial assembly, final assembly, unit test, packaging, shipping, and the like.

The operational status of each workcenter of a work area typically affects the operation of one or more other workcenters, as well as the operation of the entire work area. In some environments, some information associated with a workcenter may be entered and/or stored, either manually or automatically without human intervention, in an enterprise resource planning (ERP) system. However, such information is not normally available in a “real-time” manner to managers and employees associated with the work area. Additionally, access to such information is typically only possible by way of a desktop or laptop computing system, neither of which is convenient for use on a shop floor or similar environment. To combat this lack of information, time-critical information regarding a workcenter is often communicated directly from one employee to another in the work area via word-of-mouth, phone call, SMS (Short Message Service) messages, email, and the like. As a result, the likelihood of that information being passed to all interested parties in the work area is typically less than desirable.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example system for accessing enterprise work area information using a mobile communication device;

FIG. 2 is a block diagram of an example mobile communication device employable in the system of FIG. 1;

FIG. 3 is a block diagram of an example workcenter data access system employable in the system of FIG. 1;

FIG. 4 is a flow diagram illustrating an example method of presenting work area information via a floor plan display including representations of multiple workcenters;

FIG. 5 is a flow diagram illustrating an example method of designing the floor plan display and the associated workcenter representations;

FIGS. 6A through 6K provide example mobile communication device display screenshots provided by an application executing on the mobile communication device for retrieval of enterprise work area information; and

FIG. 7 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

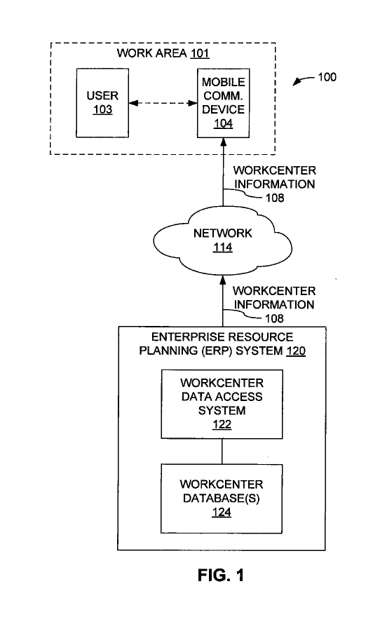

FIG. 1 is a block diagram of an example system 100 for accessing enterprise work area information using a mobile communication device. Generally, the system 100 includes a mobile communication device 104 that may communicate with an enterprise resource planning (ERP) system 120, such as an ERP system provided by SAP AG of Walldorf, Germany. Generally, the ERP system 120 may facilitate and manage the generation and modification of, and user access to, numerous types of data across a business enterprise or organization. Such data may include, but are not limited to, data concerning raw manufacturing materials, finished products, sales and marketing activities, engineering, manufacturing, testing, enterprise finances, corporate taxes, employee compensation and benefits, and the like. Accordingly, the ERP system 120 may host applications relating to, for example, product lifecycle management, supply chain management, customer relationship management, corporate financial management, human resources activities, and so on. To facilitate at least some of these applications, the ERP system 120 may include a workcenter data access system 122 and one or more workcenter databases 124 relating to the operational status of, and associated information related to, workcenters of one or more work areas of an enterprise or entity.

A work area may be any definable geographic area or location in which multiple workcenters of an enterprise or entity are located. Such work areas may include, for example, a building, a particular floor or area of a building, or other contiguous area at which activities of the enterprise or entity may occur. Example work areas include, but are not limited to, warehouses, shop floors, productions floors, and so on.

Further, within a particular work area may be located a number of workcenters, wherein each workcenter is an operational unit or group associated with a particular function or group of operations associated with an enterprise or entity. Examples of workcenters may include, but are not limited to, a receiving department, a manufacturing department, an initial or final assembly department, a testing department, a packaging and/or shipping department, and so on.

Examples of the mobile communication device 104 of FIG. 1 may include, but are not limited to, smart phones, personal digital assistants (PDAs), tablet computers, and laptop computers. As a result, the mobile communication device 104 may be capable of communicating wirelessly with other communication devices, including the ERP system 120. In at least some of the examples described below, the mobile communication device 104 may also include an image capture device (e.g., a camera), an audio capture device (e.g., a microphone), and the like for entering information related to one or more workcenters under the direction of a user 103 of the mobile communication device 104. In other examples, the user 103 may enter such information manually into the mobile communication device 104 by way of a keypad, touchscreen, or other user input component.

As shown in FIG. 1, the mobile communication device 104 may be located at a work area 101, such as a warehouse, a manufacturing or shop floor, and so on, as described above. In other examples, the location of the mobile communication device 104 is not restricted to such a work area 101.

As depicted in FIG. 1, the mobile communication device 104 may receive workcenter information 108 regarding one or more workcenters of the work area 101 via a communication network 114 from the ERP system 120 described above. In one example, the mobile communication device 104 may provide an indication of the particular work area 101 of interest, such as by way of a configuration file stored in the mobile communication device 104 or the ERP system 120, by way of information indicating a geographical location of the mobile communication device 104 (e.g., Global Positioning System (GPS) data acquired via GPS circuitry located in the mobile communication device 104), or via other means. In one example, the network 114 may be a local area network (LAN), a wide area network (WAN, such as the Internet or an Intranet), a cell phone network (such as a 3G (third generation) or 4G (fourth generation) network), or some other communication network, including combinations thereof.

As discussed more fully below, the workcenter information 108 may include an overall operational status of each workcenter of the work area 101, more detailed operational status information or metrics regarding one or more aspects or characteristics of each workcenter, data regarding items (e.g., manufactured items, items to be shipped, and so on) associated with one or more of the workcenters, data related to customer or production orders involving one or more of the workcenters, and so on. Such data may be retrieved from the workcenter databases 124 mentioned above via the workcenter data access system 122 based on specific requests from the mobile communication device 104. Alternatively, such data may be “pushed” to the mobile communication device 104 by the workcenter data access system 122, such as when data associated with a workcenter changes. Such data may be supplied to the ERP system 120 automatically via other systems associated with the workcenters, or manually via personnel associated with the workcenters.

Thus, in at least some examples of the system 100, the user 103 of the mobile communication device 104 may retrieve data pertinent to one or more of the workcenters located at the work area 101 essentially on a real-time basis, thus keeping the user 103, such as an employee or manager located at the work area 101, apprised of the operational status of each workcenter without relying on one-to-one communication with another employee, which tends to occur in an ad hoc manner. Other aspects of the embodiments discussed herein may be ascertained from the following detailed description.

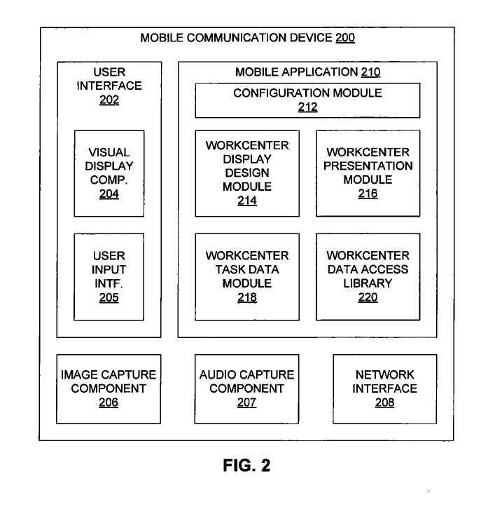

FIG. 2 is a block diagram of an example mobile communication device 200 employable as the mobile communication device 104 in the system 100 of FIG. 1. As shown in FIG. 2, the mobile communication device 200 may include a user interface 202 (including a visual display component 204 and a user input interface 205), an image capture component 206, an audio capture component 207, and a network interface 208. Also possibly included is a mobile application 210 to be executed on one or more processors (not explicitly shown in FIG. 2) of the mobile communication device 200. In the example of FIG. 2, the mobile application 210 may include several modules, including a configuration module 212, a workcenter display design module 214, a workcenter presentation module 216, a workcenter task data module 218, and a workcenter data access library 220. In other implementations, greater or fewer numbers of modules may be included in the mobile communication device 200.

The user interface 202, via its user input interface 205, may receive commands from a user, such as commands for the mobile communication device 200 to present operational status and/or related information for a particular workcenter, task, order, and the like. Examples of the user input interface 205 may include a keyboard, touchscreen, keypad, or touchpad. The user interface 202, via its visual display component 204, may also present to the user information regarding the workcenter, tasks, or orders related thereto, and other work area information (e.g., the workcenter information 108 of FIG. 1). In an example, the visual display component 204 may display a graphical representation of the workcenters as arranged within a floor plan of the work area (e.g., the work area 101 of FIG. 1). The visual display component 204 may then display the workcenter information 108 visibly linked with the graphical representations of its associated workcenters. The user interface 202 may also allow other types of input and output between the user and the mobile communication device 200. In one example, the visual display component 204 may include a display in the form of a touchscreen. In some implementations, the user interface 202 may also include a microphone, a headphone jack, one or more speakers, and so on.

Also in the mobile communication device 200, the image capture component 206 may be a camera, scanning element, or other component capable of capturing an image, such as a still photo image or a video clip. The audio capture component 207 may include a microphone and associated audio circuitry for capturing voices, sounds emitted by equipment located in one or more workcenters, and other audio signals. As is described in greater detail below, the captured images and/or audio may be stored in a memory of the mobile communication device 200 and related to a particular workcenter, or to a task, order, or other logical construct associated with a workcenter.

The network interface 208 may allow the mobile communication device 200 to communicate with other systems or devices, such as another mobile communication device and the ERP system 120 of FIG. 1. In one example, the network interface 208 may be a wireless network interface, such as an IEEE 802.11b/g/n (WiFi) interface, or a cellular 3G or 4G interface. In another example, the network interface 208 may also include a wired interface, such as an Ethernet or Universal Serial Bus (USB) interface.

The configuration module 212 of the mobile application 210 may receive user input via the user interface 202 to configure one or more aspects of the mobile application 210. In one implementation, the configuration module 212 may receive a selection of a particular work area 101, such as a specific building, floor of a building, or other definable geographical area, at which the mobile communication device 200 is located. By providing this selection, the user may limit or focus the scope of workcenter information 108 received at the mobile communication device 200 to information regarding workcenters located at the specified work area 101. In another embodiment, the location of the work area 101 may be set based on a geographical location determined by a Global Positioning System (GPS) circuit or similar means located in the mobile communication device 200. In yet other examples, the scope of the work area 101 is not restricted in such a fashion, thus allowing the user to access workcenter information 108 for any work area 101 of interest relating to the enterprise or entity. The user may select other preferences for the mobile application 210 in other examples, such as display formatting preferences, data entry preferences, image capture preferences, and so on.

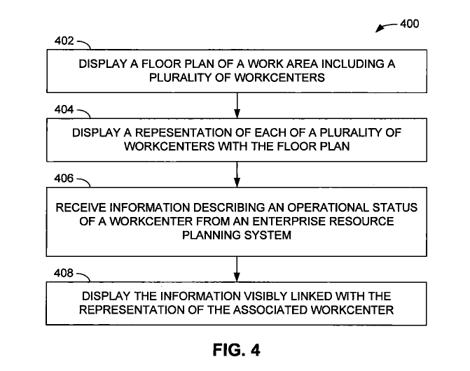

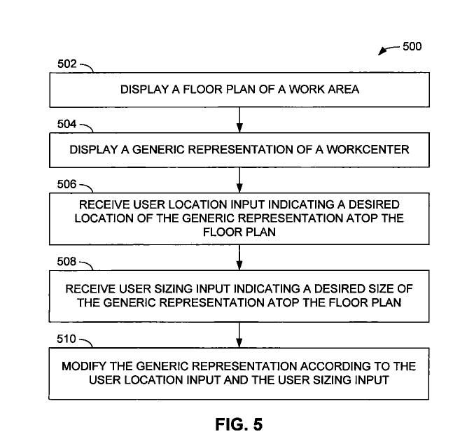

The workcenter display design module 214 may allow a user to generate and/or configure a display of a floor plan of the work area 101 populated with graphical representations of one or more workcenters of interest that are located at the work area 101. An example of this process is described below in conjunction with FIG. 5. The workcenter presentation module 216 may then display the operational status and/or other information regarding each workcenter in conjunction or logical connection with the graphical representation of that workcenter. The operation of the workcenter presentation module 216 is described in greater detail below in connection with FIG. 4.

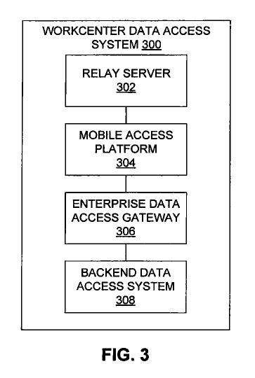

The workcenter data access library 220 may provide utilities by which the mobile communications device 200 may receive workcenter information 108 or data associated with one or more workcenters of the work area 101 of interest. For example, the workcenter data access library 220 interacts with the workcenter data access system 122 of FIG. 1 to retrieve the workcenter information 108 of interest. An example of the workcenter data access system 122 is provided in FIG. 3.

The workcenter task data module 218 may receive user input, still images, video clips, audio clips, and the like at the mobile communication device 200 and store the information as data related to one or more tasks associated with one or more of the workcenters. In one implementation, the user indicates via the user interface 202 the workcenter with which the task data is to be associated. This task data may be stored in a memory of the mobile communication device 200 and/or the ERP system 120 of FIG. 1.

FIG. 3 is a block diagram of an example workcenter data access system 300 employable as the workcenter data access system 122 of the ERP system 120 of FIG. 1. As shown in FIG. 3, the workcenter data access system 300 may include a relay server 302, a mobile access platform 304, an enterprise data access gateway 306, and a backend data access system 308. In other embodiments, less than all of these components may be employed and/or other components not specifically discussed herein may be included.

The relay server 302 may direct incoming requests or messages from the mobile communication device 104 to the mobile access platform 304 described below. The relay server 302 may also direct other incoming communication traffic, such as traffic not sourced by a mobile communication device, to other servers or platforms provided by the ERP system 120. In some environments, the relay server 302 may be considered as a type of reverse proxy server capable of directing different types of communication traffic to the particular system or group of systems capable of handling and processing the traffic.

The mobile access platform 304 may provide or facilitate functionality associated with mobile communications. One example of this functionality is user “onboarding,” in which the mobile access platform 304 facilitates initial uses of the system 100 (FIG. 1) by a user, such as by providing step-by-step instructions for setting up a user identity or logon onto the system 100, or for performing basic functions provided by the system 100, such as the issuing of requests for workcenter information 108, or for storing such information being sourced by a mobile communication device 104. The mobile access platform 304 may also perform any user or device authentication to allow the user to access the workcenter information 108 or data stored in the ERP system 120. Other functions, such as push notifications for notifying the user of the mobile communication device 104 of special events, status, or errors associated with the workcenters that are noted in the ERP system 120, may also be provided by the mobile access platform 304.

The enterprise data access gateway 306 may convert or reformat incoming communications into communications understandable by the underlying backend data access system 308. As a result, multiple ERP systems 120 may be accessed by a mobile communication device 104 presuming the presence of an enterprise data access gateway 306 associated with each ERP system 120 to be accessed. More specifically, each enterprise data access gateway 306 may translate the incoming communications associated with the protocol associated with the mobile access platform 304 to a particular data protocol employed in the backend data access system 308.

The backend data access system 308 may perform a search of one or more workcenter databases 124 based on an identification of work area 101 or the workcenters included therein, or a geographical location (e.g., a location identified by GPS data, or a location entered manually by the user) of the mobile communication device 104. In other examples, the backend data access system 308 may perform the search using any workcenter database 124 associated with the user employing the mobile communication device 104, such as any work area 101 of the enterprise employing the user, or any such work area 101 associated with the user (or for which the user maintains some level of responsibility), thus facilitating access to status information for work areas 101 remotely located from the mobile communication device 104. In one example, the functionality of the search may be controlled by other information, such as the identity of the mobile application 210 being executed in the mobile communication device 104, and by other information or factors accessible by the backend data access system 308. The workcenter databases 124 being accessed by the backend data access system 308 may include databases associated primarily with design engineering, production engineering, test engineering, marketing, sales, and other organizations serviced by the ERP system 120. The resulting workcenter information 108 may take many forms, depending on the ERP system 120, including, but not limited to, database entries, text or word processing documents, spreadsheets, and so on.

The backend data access system 308 may then return the workcenter information 108 to the mobile communication device 104 via the enterprise data access gateway 306, the mobile access platform 304, the relay server 302, and the communication network 114. Such information may be provided in response to an explicit request from the mobile communication device 104 indicating a particular work area 101 or workcenter located therein. The request may be periodic or intermittent in nature. In another example, the workcenter information 108 may be provided via a push mechanism that updates the workcenter data for a work area 101 for each change in the information as detected by the ERP system 120 in response to a single request for such data from the mobile communication device 104.

FIG. 4 is a flow diagram illustrating an example method 400 of accessing and displaying workcenter information, such as the workcenter information 108 of FIG. 1. In the method 400, a floor plan of a work area (e.g., the work area 101 of FIG. 1) that includes a plurality of workcenters is displayed (operation 402). Also displayed with the floor plan is a representation of each of the plurality of workcenters (operation 404). In one example, the representation of each workcenter on the display occupies the portion of the floor plan corresponding to the location of the workcenter within the actual work area 101.

Information describing an operational status (e.g., the workcenter information 108 of FIG. 1) of at least one of the workcenters is received from an enterprise resource planning system (e.g., the ERP system 120 of FIG. 1) (operation 406). This information may be received from the ERP system 120 in response to poll messages received periodically at the ERP system 120 in one example. In other implementations, the ERP system 120 may transfer the information periodically, or immediately in response to changes to that information, in response to a previous request for the workcenter information 108 from the mobile communication device 104. Also, the information may include, for example, an overall status indication of the operation of the workcenter, more specific numeric information associated with a particular metric or characteristic of the workcenter, and/or information describing a trend (e.g., rising or falling) of a metric or characteristic of the workcenter. The information for each workcenter may then be displayed while visibly linking that information with the representation of the associated workcenter (operation 408). In one example, the information for each workcenter is displayed within or atop the graphical representation of its associated workcenter.

While the operations 402 through 408 of the method 400 of FIG. 4 are shown in a specific order, other orders of operation, including possibly concurrent or continual execution of at least portions of one or more operations, may be possible in some implementations of method 400, as well as other methods discussed herein.

FIG. 5 is a flow diagram illustrating an example method 500 of designing the floor plan display and the associated workcenters mentioned above in conjunction with the method 400 of FIG. 4. In the method 500, a floor plan of a work area (e.g., the work area 101 of FIG. 1) is displayed (operation 502). Also displayed is a generic representation of a workcenter (operation 504). User location input indicating a desired location of the generic representation atop or within the floor plan (operation 506), and user sizing input indicating a desired size of the generic representation atop or within the floor plan (operation 508) are received. The generic representation is modified according to the user location input and the user sizing input (operation 510), resulting in the graphical representation of one of the workcenters of the work area 101 with which operational status and related information associated with the workcenter is displayed, as accomplished via the method 400 of FIG. 4.

While much of the description of work areas and workcenters provided herein involves typical enterprise manufacturing or distribution environments, other types of work areas not specifically discussed herein may also benefit from the various techniques presented. Examples of such work areas may include retail environments involving sales areas (e.g., different departments of a grocery or department store), equipment repair or refurbishing centers including a number of repair and testing stations, and the like.

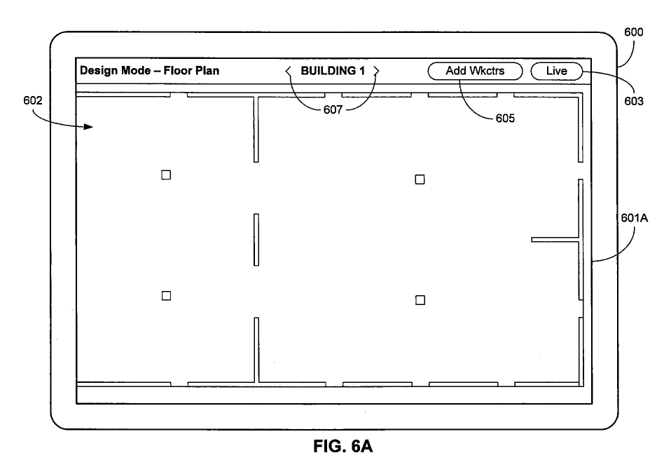

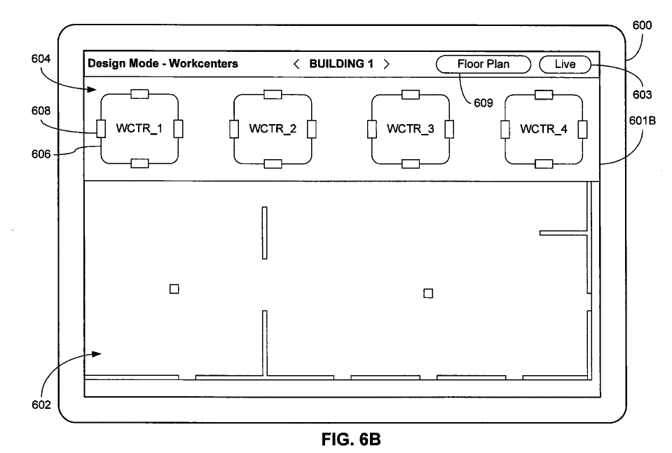

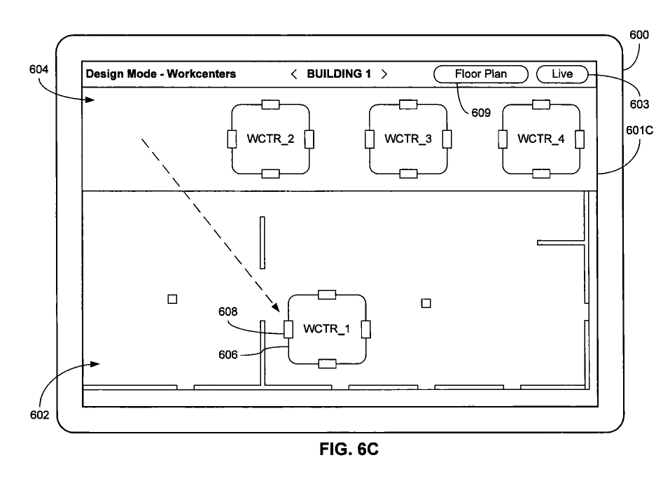

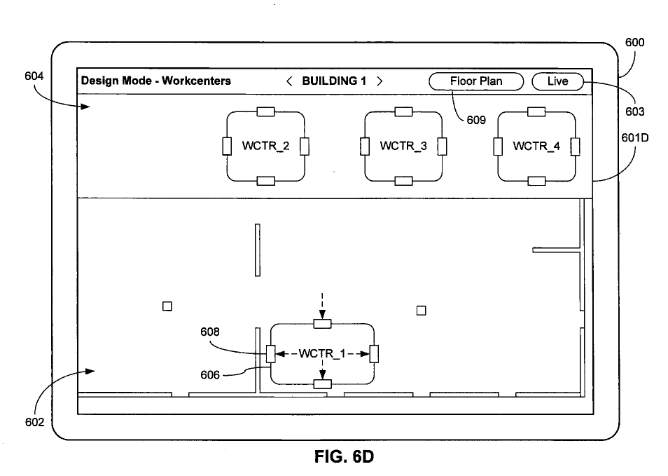

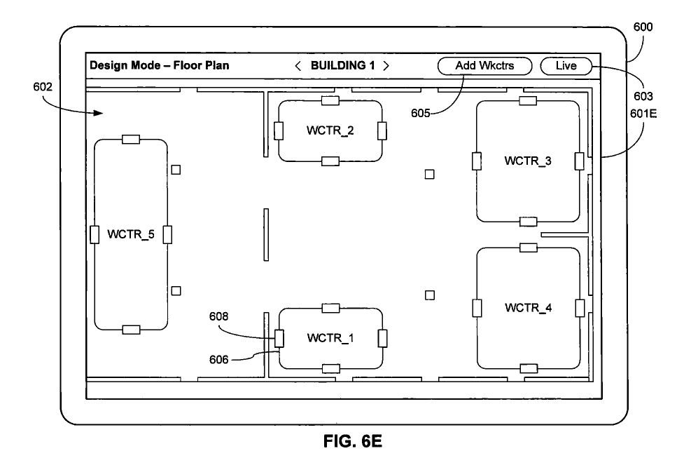

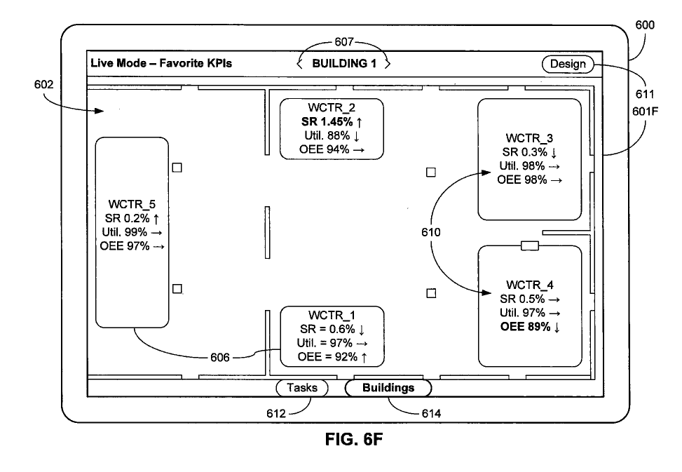

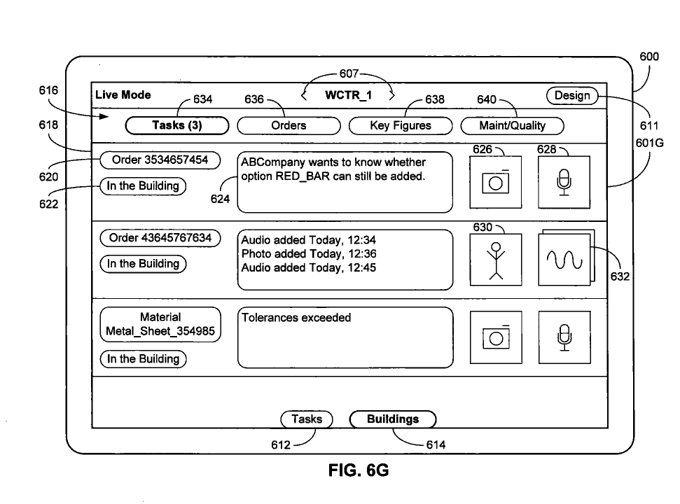

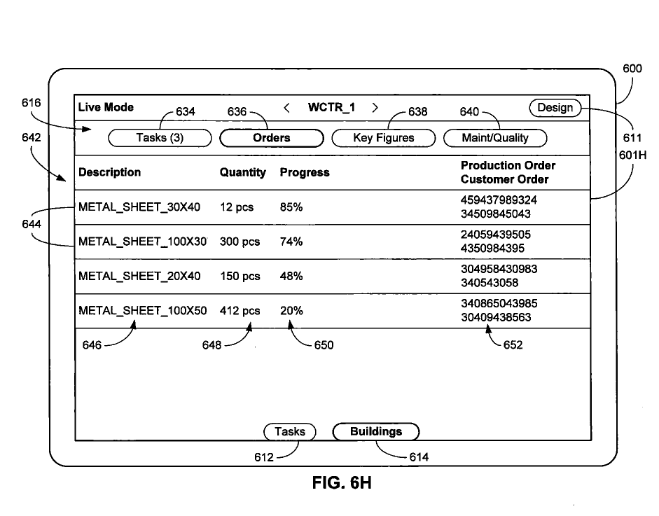

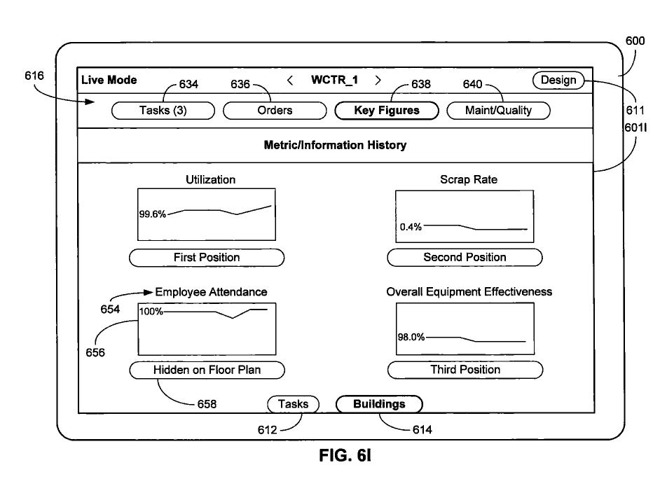

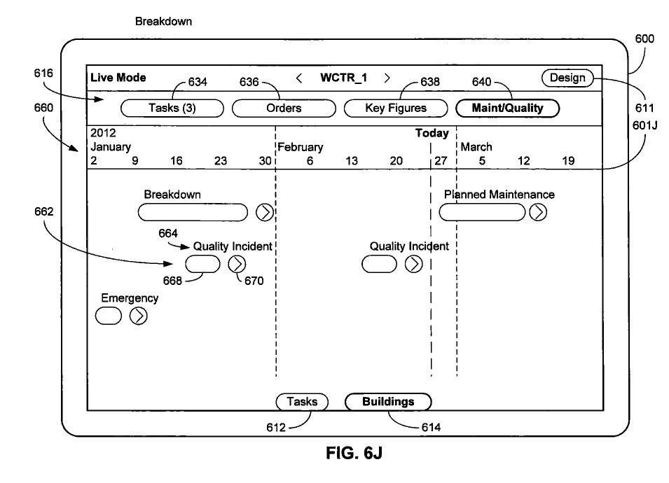

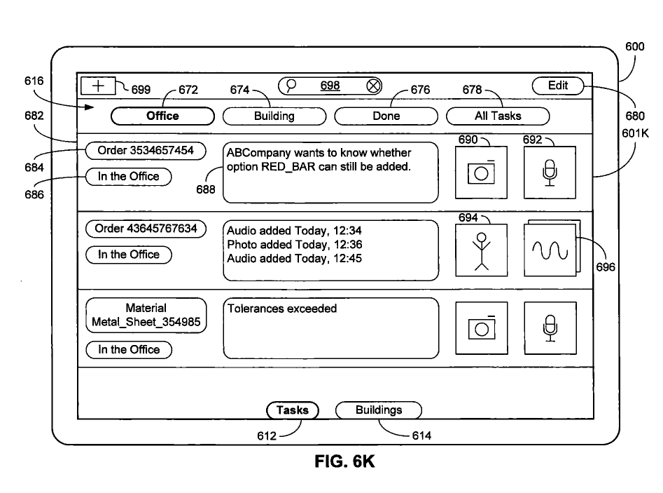

Presuming a shop floor environment, FIGS. 6A through 6K provide example display screenshots presented on a touchscreen or similar display component of a mobile communication device 600 (which may be an example of the mobile communication device 200 of FIG. 2) by an application (e.g., the mobile application 210 of FIG. 2) executing on the mobile communication device 600 for access and display of information associated with one or more workcenters of a work area (e.g., the work area 101 of FIG. 1). In an example, execution of the mobile application 210 may be initiated by activating an icon on a touchscreen display of multiple application icons representing applications loaded on the mobile communication device 600. In some examples, such a display may be termed a “home screen”. In some implementations, the mobile application 210 may prompt the user of the mobile communication device 200 to enter a username, a password, and/or other information that may be used for verification and/or authentication by an ERP system (e.g., the ERP system 120 of FIG. 1) of the user or the mobile communication device 600 to permit the user to access the ERP system 120.

While the presence of a touchscreen for the mobile communication device 600, as what may be supplied on a tablet computer, is presumed in the examples described herein, the mobile communication device 600 is not limited to a tablet computer, but may be any mobile communication device capable of performing various operations described herein.

FIGS. 6A through 6E present example screenshots associated with the designing, generating, or configuring of a display of a floor plan populated with multiple representations of workcenters, as described via the method 500 of FIG. 5, while FIGS. 6F through 6K illustrate example screenshots corresponding to the display of workcenter information as discussed via the method 400 of FIG. 4, employing the display generated using the method 500. In one example, within the context of the mobile application 210, the generation of the floor plan populated with graphical representations of workcenters may be termed “Design Mode,” while the use of the resulting display for presentation of operational status and associated data for each workcenter may be referred to as “Live Mode.”

In the example of FIG. 6A, the mobile application 210 may present an initial floor plan screen 601A through which a floor plan 602 of a work area 101 unpopulated by graphical representations of workcenters may be displayed. In one example, the floor plan 602 may be retrieved from the ERP system 120 or another system. In some implementations, the floor plan 602 may be derived from the actual plans of the building in which the work area 101 resides, or may be generated specifically for use by the mobile application 210. As shown in FIG. 6A, the floor plan 602 may include various details, such as interior and exterior walls, support columns, windows, doorways, and the like. However, any level of detail that allows a user to discern various locations within the work area 101 may be provided in the floor plan 602 in other implementations.

As exhibited in FIG. 6A, the initial floor plan screen 601A is labeled “Building 1”. This label may be set by the user, accompany the floor plan 602 as received, or merely represent a generic term provided by the workcenter display design module 214 of the mobile application 210. A pair of directional buttons 607 may also be provided to allow navigation from one building or floor plan 602 to another floor plan for a different work area. In another example, the user may simply swipe the screen in a horizontal motion, to the left or right, to navigate to another floor plan 602. Also provided may be an “Add Workcenters” button 605 to navigate to another screen (shown in FIG. 6B) that allows the user to begin adding workcenters to the floor plan 602. Further included may be a “Live” button 603 that allows the user to navigate to the Live Mode portion of the mobile application 210, described in greater detail below.

Presuming the user activates the “Add Workcenters” button 605, the mobile application 210 may display an initial add workcenters screen 601B of FIG. 6B. The add workcenters screen 601B may provide a view of the floor plan 602 overlaid with a window 604 including one or more generic workcenters 606, labeled in FIG. 6B as WCTR_1, WCTR_2, and so on. As shown in FIGS. 6C and 6D, the user may employ these generic workcenters 606 as workcenters populating the floor plan 602 for later use. Each of the generic workcenters 606 includes one or more graphical handles 608 for altering the size and shape of its associated generic workcenter 606 for adding to the floor plan 602. The add workcenters screen 601B also includes a “Floor Plan” button 609 to return to the floor plan screen 601A described in FIG. 6A.

FIG. 6C presents a second add workcenters screen 601C in which the user has dragged the WCTR_1 generic workcenter 606 onto a desired location of the floor plan 602. The third add workcenters screen 601D of FIG. 6D shows further manipulation of the WCTR_1 generic workcenter 606 as a result of the user dragging the handles 608 of the workcenter 606 to adjust the size of the workcenter 606 to match substantially the location, size, and shape of the corresponding actual workcenter located in the work area 101 represented by the floor plan 602. Instead of the handles 608 being located on the sides of the generic workcenter 606, other graphical constructs allowing the user to adjust the size and shape of the generic workcenter 606, possibly allowing non-rectangular shapes for the workcenter 606, may be supplied in other embodiments.

While FIGS. 6B through 6D indicate that the generic workcenters 606 are accessed after the floor plan 602 has been retrieved, other examples may allow at least selection, and possibly relocation and resizing, of the generic workcenters 606 prior to retrieval and display of the floor plan 602.

After the user has selected, located, and sized each of the workcenters 606 WCTR_1 through WCTR_5 to be placed on the floor plan 602, the user may activate the Floor Plan button 609. In response to the activation, the mobile communication device 600 may present an updated floor plan screen 601E, as depicted in FIG. 6E, displaying each of the workcenters 606 to be displayed on the floor plan 602. In some implementations, further relocating and sizing of the workcenters 606 may occur in the updated floor plan screen 601E, facilitated in part by the removal of the generic workcenter window 604.

In some examples, either the configuration module 212 or the workcenter display design module 214 of the mobile application 210 may allow the user to adjust the brightness, contrast, and other characteristics of the floor plan 602, the workcenters 606, or both to present an easily viewable display from the standpoint of the user. Other aspects of the display, such as the amount of data to be presented for each of the workcenters 606, may also be user-configurable.

If the user has completed the population of the floor plan 602 with all desired workcenters 606, the user may then activate the Live button 603, causing the mobile communication device 600 to operate the mobile application 210 in Live Mode. An example Live Mode screen 601F displaying operational information 610 for each workcenter 606 is illustrated in FIG. 6F. More specifically, the workcenter presentation module 216 may display each of the workcenters 606 represented on the floor plan 602 with a value for each of one or more key performance indicators (KPIs), along with a trend indicator in the form of an appended arrow. The operational status or related information for each workcenter 606 is displayed atop or within its respective workcenter 606 representation. In the specific example of FIG. 6F, the operational information 610 includes a scrap rate (SR) for material employed at the workcenter 606, a utilization percentage (Util.) for the workcenter 606, and an overall equipment effectiveness percentage (OEE) of the workcenter 606. However, different operational information 610 other than that shown in FIG. 6F, as well as greater or less amounts of operational information 610, may be provided for each workcenter 606. Further, the types of operational information 610 being displayed may be different for various ones of the workcenters 606 in some embodiments. In each case, the operational information 610 is associated with its respective workcenter 606 by visibly linking the operational information 610 with the correct workcenter 606, such as by displaying the information atop the associated workcenter 606 (as shown in FIG. 6F), by displaying the information next to the associated workcenter 606, or by other means.

In the example of FIG. 6F, the operational information 610 for workcenter WCTR_2 indicates a scrap rate of 1.4% and rising, a utilization percentage of 88% and falling, and an OEE of 94% and holding steady. Further, the scrap rate percentage and associated trending indicator are presented in bold to draw the attention of the user to a potential problem at WCTR_2. The OEE percentage for WCTR_4 is also enhanced in a similar fashion. In other examples, information deemed more important or critical may be enhanced in some other manner, such as by presenting the information in a different color, or in an animated (e.g., flashing) fashion. Such information may be deemed more important if a value represented by the information lies outside some predetermined range.

In one implementation, the displayed operational information 610 for each of the workcenters 606 may be updated repeatedly. To maintain up-to-date operational information 610, the workcenter presentation module 216 may request or query the information periodically from the ERP system 120 via the network 114 and the workcenter data access system 122. Each query may include an indication of the KPIs to be displayed for each of the workcenters 606. In response to such requests, the workcenter data access system 122 may retrieve the requested information from one or more workcenter databases 124 and return the accessed information to the mobile communication device 600 via the network 114.

In another example, the workcenter presentation module 216 may transmit a message via the network 114 to the ERP system 120 to initiate “push” data transfers from the ERP system 120, with each data transfer including up-to-date operational information 610 for display on the mobile communication device 600. In some examples, the data transfers may occur on a periodic basis, such as once a minute, once every 10 minutes, and the like. In other implementations, the data transfers may occur when a change in the data being presented is detected in the workcenter databases 124.

As in Design Mode, the Live Mode screen 601F displaying the KPIs for each workcenter 606 may include a label for the work area 101 (e.g., Building 1) along with directional buttons 607 for navigating to other floor plans populated with graphical representations of workcenters 606 and associated operational information 610. In another example, instead of using directional buttons 607, the user may instead swipe the screen in a horizontal motion to navigate to other floor plans. The Live Mode screen 601F also provides a “Design” button 611 to allow the user to transition the mobile application 210 back to Design Mode.

Also displayed in the Live Mode screen 601F are a “Tasks” button 612 and a “Buildings” button 614 that allow access to a Tasks sub-mode and a Buildings sub-mode, respectively. By highlighting the Buildings button 614, the workcenter presentation module 216 indicates to the user that the mobile application 210 is currently in the Buildings sub-mode, thus allowing the user to view the current values of the KPIs of each workcenter 606 of a work area 101 (e.g., Building 1). Activation of the Tasks sub-mode enables the user to store text, still images, video clips, audio segments, and/or the like for each of a number of tasks to be addressed by the user. A more detailed description of the Tasks sub-mode is provided below in conjunction with FIG. 6K.

In response to the user activating (e.g., touching) one of the graphical representations of the workcenters 606 (in this case WCTR_1), the workcenter presentation module 216 may display a Live Mode building tasks screen 6010, an example of which is depicted in FIG. 6G. In the Live Mode building tasks screen 601G, a list of tasks 618 associated with the selected workcenter 606 are displayed. Each task 618 may include an identifier 620, such as an order number, an item description, or other identifier. The identifier 620 may be entered manually by the user, selected from a list of identifiers by a user, or generated automatically by a computer system, such as the ERP system 120.

Also included may be an indicator as to where the task 618 may be accomplished or addressed (e.g., “In the Building” or “In the Office”). In one example, each of the tasks 618 listed in the Live Mode building tasks screen 601G are building-related. Each of the tasks 618 may be generated by the user of the mobile communication device 600, by another employee or manager, or automatically by another system, such as the ERP system 120.

Also included with each task 618 may be a text field 624 providing data or status regarding the task 618 to be completed. The user may generate or update the text in the text field 624 via a keyboard, the touchscreen, or other means provided by the mobile communication device 600. Also presented for each task 618 may be one or more capture photo buttons 626 and one or more capture audio clip buttons 628 to allow the user to capture still images or video clips (e.g., using the image capture component 206) and audio clips (e.g., using the audio capture component 207) and associate them with the task 618. The user may also play back previously captured audio clips using a play audio button 632, and view video and/or still images using a view image button 630. In one example, the user may also activate the view image button 630 and the play audio button 632 to capture additional audio, video, and still image data associated with the corresponding task 618. For example, the user may capture a photo of an item of faulty equipment or a produced item that does not conform to specifications. Similarly, the user may capture audio of the voice of the user to take verbal notes concerning the task, or to capture sound associated with a particular piece of equipment of the workcenter 606 associated with the task 618 (e.g., WCTR_1).

In the example of FIG. 6G, the buildings sub-mode of Live Mode may facilitate user access to four separate screens via four corresponding buttons: a Tasks button 634, an Orders button 636, a Key Figures button 638, and a Maintenance/Quality button 640, each of which, when activated, causes a corresponding screen to be displayed. For example, activation of the Tasks button 634 results in the display of the Live Mode building tasks screen 6010 described above. In a particular example, the Tasks button 634 also indicates the number of outstanding tasks (e.g., three in FIG. 6G) associated with the selected workcenter 606. In one implementation, activation of one of the buttons 634-640 causes that particular button to be emphasized in some manner (e.g., highlighted, flashing, text in bold, etc.)

If, instead, the user activates the Orders button 636, the workcenter presentation module 216 may present an orders screen 601H, an example of which is illustrated in FIG. 6H. On the orders screen 601H, a list 642 of orders 644 associated with the selected workcenter 606 is displayed. Each order 644 entry may include a description 646 of the item or material that is the object of the order 644, a quantity 648 of the item or material in the order 644, a progress indicator 650 for completing the order 644 (e.g., a percentage, a time to complete, a progress bar, etc.), and one or more identifiers 652 (e.g., a production order number or a customer order number) associated with the order 644. The order information may thus apprise the user of the mobile communication device 600 of the current status of any or all orders 644 associated with the selected workcenter 606.

Upon activation of the Key Figures button 638, either the workcenter presentation module 216 or the configuration module 212 may provide a Key Figures screen 601I, an example of which is presented in FIG. 6I. Presented on the Key Figures screen 601I may be a set of possible metrics/information histories 654 that may be displayed for each of the workcenters 606 on the Live Mode screen 601F described above. In the example of FIG. 6I, each metric/information history 654 may display a running history of time series data for some recent time period (e.g., the last seven days) for the particular metric as a chart, histogram, list of values, or other data presentation format. In some examples, each metric/information history 654 may also project or forecast values of the metric in the near future based on previous history, current status data, and the like. As shown in the example of FIG. 6I, each metric/information history 654 may be annotated with an identifier 654 or description of the metric or informational item involved, along with a position button 658 that, when activated by the user, may alter whether the metric or informational item is displayed on the Live Mode screen 601F, and in what position the metric or information item may be displayed. Further, by repeatedly activating one of the position buttons 658, the user may cycle through each of the different possibilities regarding display and position. In one example, the user may select the identifier 654 for the metric or information item from a list of such items supplied by the ERP system 120 via the network 114. While only four different types of metrics or informational items are depicted in FIG. 6I, any number of different types may be selectable by the user in other examples. According to the particular selections shown in FIG. 6I, utilization is displayed first, scrap rate is displayed second, and OEE is presented third, while employee attendance is hidden in the view of the floor plan 602. In some examples, those metrics or informational items selected as hidden may be viewable via other screens presented to the user by the workcenter presentation module 216.

User selection of the Maintenance/Quality button 640 may result in display of a timeline screen 601J, an example of which is provided in FIG. 6J. The timeline screen 601J may provide a linear calendar 660 upon which one or more maintenance/quality events 662 associated with the selected workcenter 606 are indicated. In this example, each event 662 is labeled with an identifier 664 (such as a type of the event 662 (e.g., quality incident, breakdown, emergency, or planned maintenance)), a duration indicator 668 indicating the length of time during which the event 662 occurred, and a detail button 670 that, when activated, may provide more detailed information describing the event 662. While the timeline screen 601J displays the events 662 against a horizontal timeline, other methods of displaying the events relative to some period of time may be employed in other examples.

In response to a user activating the Tasks button 612 while viewing any of the screens 601F through 601J of Live Mode, as shown in FIGS. 6F through 6J, the workcenter task data module 218 may present a tasks screen 601K, an example of which is depicted in FIG. 6K. Similar to the Live Mode building tasks screen 601G of FIG. 60, the tasks screen 601K may display one or more tasks 682, each of which may provide an identifier 684 (e.g., an order number, a material description, etc.), a location indicator 686 (e.g., in the office, or in the building), a text field 688, and one or more capture photo buttons 690 with one or more capture audio clip buttons 692 to allow the user to capture still images, video clips, and/or audio clips associated with the task 682. The user may also play back previously captured audio clips via activation of a play audio button 696, and view video and/or still images using a view image button 694.

Instead of limiting the display of tasks 682 to those associated with a particular workcenter 606, as was the case with the Live Mode building tasks screen 601G of FIG. 6G, all tasks associated with the user of the mobile communication device 600 may be presented, or optionally filtered according to different criteria. For example, the tasks screen 601K may provide a number of buttons to filter the tasks 682 being displayed: an Office button 672 that restricts the display to only those tasks 682 that may be performed in an office environment (as opposed to the work area 101), a Building button 674 that causes the display of only those tasks 682 that may be accomplished at the work area 101, a Done button 676 that causes the display of only those tasks 682 that have been completed, and an All Tasks button 678 that causes the display of all tasks 682 associated with the user of the mobile communication device 600. Also provided in the tasks screen 601K is a search field 698 allowing a user to enter search text in order to display one or more tasks 682 corresponding to the entered search text. The user may also manually add new tasks 682 via an Add Task button 699. Further, an Edit button 680 may be provided to allow a user to edit a preexisting task 682, such as by modifying the text in the text field 688, and/or by adding or removing any audio, video, or still image clips, possibly via the play audio button 696 and the view image button 694.

As a result of at least some of the embodiments described above, a user may employ a mobile communication device (e.g., the mobile communication device 104 of FIG. 1) to access information, such as operational status and other metrics or information, related to or associated with a workcenter of a physical work area, such as a warehouse or shop floor. The information is received via a network from an ERP system (e.g., the ERP system 120 of FIG. 1), which may serve as a central data access point for all information associated with all workcenters of the work area. As a result, all employees, including managers, supervisors, and others, may possess near-instantaneous access to any workcenter-related information that may impact the employee and associated workgroup. Additionally, the ERP system may serve as a focal point through which an employee may disseminate such information to others in the organization. Such access by multiple users to the same data of various work areas promotes transparent access to work information, and thus collaboration between the various parties, possibly in support of lean management principles. In some examples, the users may also author and store paperless notes, tasks, and so on, thus facilitating simple generation and subsequent access to work-related information in support of continuous improvement processes often implemented in corporate enterprises.

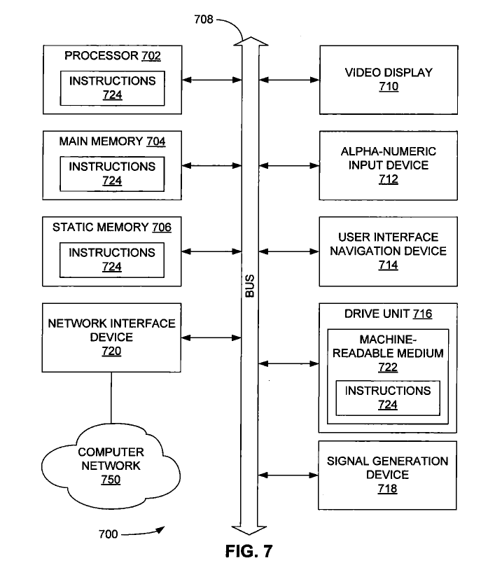

FIG. 7 depicts a block diagram of a machine in the example form of a processing system 700 within which may be executed a set of instructions 724 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 700 includes a processor 702 (e.g., a central processing unit (CPU), a graphics processing unit (GPU), or both), a main memory 704 (e.g., random access memory), and static memory 706 (e.g., static random-access memory), which communicate with each other via bus 708. The processing system 700 may further include video display unit 710 (e.g., a plasma display, a liquid crystal display (LCD), or a cathode ray tube (CRT)). The processing system 700 also includes an alphanumeric input device 712 (e.g., a keyboard), a user interface (UI) navigation device 714 (e.g., a mouse), a disk drive unit 716, a signal generation device 718 (e.g., a speaker), and a network interface device 720.

The disk drive unit 716 (a type of non-volatile memory storage) includes a machine-readable medium 722 on which is stored one or more sets of data structures and instructions 724 (e.g., software) embodying or utilized by any one or more of the methodologies or functions described herein. The data structures and instructions 724 may also reside, completely or at least partially, within the main memory 704, the static memory 706, and/or within the processor 702 during execution thereof by processing system 700, with the main memory 704 and processor 702 also constituting machine-readable, tangible media.

The data structures and instructions 724 may further be transmitted or received over a computer network 750 via network interface device 720 utilizing any one of a number of well-known transfer protocols (e.g., HyperText Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 700) or one or more hardware modules of a computer system (e.g., a processor 702 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 702 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 702 that is configured using software, the general-purpose processor 702 may be configured as respective different hardware modules at different times. Software may accordingly configure a processor 702, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 702 or processor-implemented modules. The performance of certain of the operations may be distributed among the one or more processors 702, not only residing within a single machine but deployed across a number of machines. In some example embodiments, the processors 702 may be located in a single location (e.g., within a home environment, within an office environment, or as a server farm), while in other embodiments, the processors 702 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method, comprising:
displaying a floor plan of a work area including a plurality of workcenters;
displaying a representation of each of the plurality of workcenters with the floor plan, the representations being displayed according to physical locations of the plurality of workcenters within the work area;
receiving, from an enterprise resource planning system, information describing an operational status of one of the plurality of workcenters; and
displaying, using at least one processor of a machine, the information describing the operational status of the one of the plurality of workcenters, the information being visibly linked with the representation of the one of the plurality of workcenters.

2. The method of claim 1, the information being visibly linked with the one of the plurality of workcenters by overlaying the information atop the representation of the one of the plurality of workcenters.

3. The method of claim 1, further comprising:
receiving a user selection of the one of the plurality of workcenters;
the displaying of the information describing the operational status of the one of the plurality of workcenters being in response to the receiving of the user selection.

4. The method of claim 1, the information comprising an operational metric of the one of the plurality of workcenters.

5. The method of claim 4, the operational metric comprising one of a scrap rate of a material employed at the one of the plurality of workcenters, a utilization percentage of a material employed at the one of the plurality of workcenters, a capacity percentage at which the one of the plurality of workcenters is operating, and an overall equipment effectiveness of the one of the plurality of workcenters.

6. The method of claim 1, the information comprising an indication of attendance of employees associated with the one of the plurality of workcenters.

7. The method of claim 1, the information comprising an alert indicating an operational metric of the one of the plurality of workcenters lying outside a predetermined range.

8. The method of claim 1, the information comprising at least one key performance indicator corresponding to performance of the one of the plurality of workcenters.

9. The method of claim 1, the information comprising at least one outstanding task to be accomplished at the one of the plurality of workcenters.

10. The method of claim 1, the information comprising a metric indicating progress toward completion of an order being fulfilled at the one of the plurality of workcenters.

11. The method of claim 1, the information comprising a timeline indicating at least one prior or future event involving the one of the plurality of workcenters.

12. The method of claim 11, the event comprising one of an equipment breakdown at the one of the plurality of workcenters, a planned maintenance activity at the one of the plurality of workcenters, an emergency at the one of the plurality of workcenters, and a quality incident at the one of the plurality of workcenters.

13. The method of claim 1, further comprising:
capturing media content comprising at least one of a still image, a video clip, and an audio clip;
receiving input from a user indicating the one of the plurality of workcenters; and
associating the captured media content with the one of the plurality of workcenters based on the received input.

14. The method of claim 1, further comprising:
displaying a generic representation of a workcenter;
receiving user location input indicating a desired location of the generic representation atop the floor plan of the work area;
receiving user sizing input indicating a desired size of the generic representation; and
modifying the generic representation according to the user location input and the user sizing input to yield the representation of the one of the plurality of workcenters.

15. A non-transitory computer-readable storage medium comprising instructions that, when executed by at least one processor of a mobile communication device, cause the mobile communication device to perform operations comprising:
displaying a floor plan of a work area including a plurality of workcenters;
displaying a representation of each of the plurality of workcenters with the floor plan, the representations being displayed according to physical locations of the plurality of workcenters within the work area;
receiving, from an enterprise resource planning system, information describing an operational status of one of the plurality of workcenters; and
displaying the information describing the operational status of the one of the plurality of workcenters, the information being visibly linked with the representation of the one of the plurality of workcenters.

16. The non-transitory computer-readable storage medium of claim 15, the operations further comprising:
receiving a user selection of the representation of the one of the plurality of workcenters;
the displaying of the information being in response to the user selection.

17. A mobile communication device, comprising:
a visual display component;
a network interface to exchange communications between the mobile communication device and an enterprise resource planning system;
at least one processor; and
a memory storing modules comprising instructions to be executed by the at least one processor, the modules comprising:
a workcenter presentation module to display, via the visual display component, a floor plan of a work area and a representation of each of a plurality of workcenters included in the work area, the representations being displayed according to physical locations of the plurality of workcenters within the work area; and
a workcenter data access library to receive, from the enterprise planning system via the network interface, information describing an operational status of one of the plurality of workcenters;
the workcenter presentation module to present, via the visual display component, the information describing the operational status of the one of the plurality of workcenters, the information being visibly linked with the representation of the one of the plurality of workcenters.

18. The mobile communication device of claim 17, further comprising:
a user input interface to receive a user selection of the representation of the one of the plurality of workcenters;
the workcenter presentation module to present, via the visual display component, the information based on the user selection.

19. The mobile communication device of claim 17, further comprising:
a user input interface to receive a user selection of the representation of the one of the plurality of workcenters, and to receive user data for a task associated with the one of the plurality of workcenters;
the modules further comprising a workcenter task data module to store the user data and to associate the user data with the one of the plurality of workcenters for subsequent display via the visual display component.

20. The mobile communication device of claim 17, the modules further comprising:
a workcenter display design module to present, via the visual display component, generic workcenter representations;
the mobile communication device further comprising a user input interface to receive user input to locate and size the generic workcenter representations relative to the floor plan of the work area; and
the workcenter display design module to produce the representation of the plurality of workcenters of the work area based on the user input.
